(19) United States
(12) Patent Application Publication
(10) Pub. No.: US 2015/0269550 A1
(43) Pub. Date: Sep. 24, 2015

(54) Apparatus for Improving Security for User Input and/or Access to Secure Resources and/or for Point of Sale

(71) Applicant: Verody, LLC, Piedmont, CA (US)

(72) Inventors: Kobi Eshun, Piedmont, CA (US); Donald W. Mahurin, Santa Clara, CA (US)

(73) Assignee: Verody, LLC, Piedmont, CA (US)

(21) Appl. No.: 14/719,004

(22) Filed: May 21, 2015

Related U.S. Application Data
(63) Continuation-in-part of application No. 14/207,253, filed on Mar. 12, 2014, now abandoned.
Application No. 14/207,253 is a continuation of application No. 13/367,596, filed on Feb. 7, 2012, now Pat. No. 8,726,399.
Application No. 13/367,596 is a continuation of application No. 11/657,920, filed on Jan. 24, 2007, now Pat. No. 8,146,164.
(60) Provisional application No. 60/766,506, filed on Jan. 24, 2006.
(60) Provisional application No. 62/001,179, filed on May 21, 2014.
(60) Provisional application No. 62/029,688, filed on Jul. 28, 2014.

(51) Int. Cl. G06Q 20/20; H04L 29/06

(52) U.S. Cl. CPC G06Q 20/206; H04L 63/0823; H04L 63/0853; H04L 63/0876

(57) ABSTRACT

Apparatus for improving security for user input and/or access to secure resources are disclosed that impair and/or remove the possibility of criminals sniffing such data to gain the authentic input for password and other user authentications are disclosed. Apparatus for securing customer and/or user financial information from point of sale devices so that criminals cannot use that financial information are disclosed. Methods appropriate for these apparatus are disclosed and enabled.

### TECHNICAL FIELD

This invention relates to the security of user input and/or user access to secure transactions and/or secure resources; and/or transaction security at a point of sale. The secure transactions and/or resources may include, but are not limited to, online banking, stock trading, and e-commerce, as well as personal user access to social networks, email servers and instant messaging.

### BACKGROUND OF THE INVENTION

There are widespread problems maintaining and/or providing security to users of computers. Over the last several years, there have been numerous reports about the theft of peoples' private and/or confidential information, giving criminals access to bank accounts, credit services, trading services, mercantile accounts, social networks, email and/or chat accounts. This costs individuals and institutions time and money, as well as damages consumer confidence. This malicious access can cause long term financial damage, harm reputations, and even endanger people's lives.

Most users have a limited amount of time and energy to focus on their online security. Take for example passwords. In the most perfect of situations, passwords would be chosen as essentially random strings, different for each login prompt. However, this is not common, because random strings are difficult for users to remember. What is more common, but less secure, are passwords derived from birthdays, relative's names, or names of pets.

### SUMMARY OF THE INVENTION

One aspect of this invention at least partly solves the technical problem of conveniently maintaining and/or providing security for one or more users. As used herein, providing convenient security includes denying spyware visibility to authentic input while supplying that authentic input to secure resources the user wishes to use and/or access. This prevents a keystroke sniffer from being able to capture that authentic input.

The apparatus may include one or more of the following: A convenient trusted apparatus; a trusted integration node; a memory content residing in a persistent memory; a personal computing device configured to present an offer for approval to create an agreement that configures the memory content; and/or the personal computing device configured to present a payment request for a second approval to create a revenue from the personal computing device based upon the configured memory content. One of common skill in the art will recognize that several users may legitimately operate a single personal computer over time. Frequently, only one of the legitimate users operates the device at any one time, leading to the term personal computing device as used herein.

The convenient trusted apparatus interacts with a focal computing device operated by a user to insure convenient user security for input of access credentials such as passwords and/or user name to one or more secure resources requested by the user through the focal computing device. This is done without any authentication being visible or performed by said focal computing device. The convenient trusted apparatus denies spyware visibility of the authentication on the focal computing device, which may over time be any of several personal computing devices operated by the user. For instance, the user may own a cell phone, a mobile entertainment device, a tablet computer, a smart wristband and/or a desktop computer. Consider the following examples:
When the user is using the tablet computer as the focal computing device for secured transactions, the cell phone may operate as the convenient trusted apparatus.
When the user is operating the cell phone's browser, making the cell phone the focal computing device, the wristband may operate as the convenient trusted apparatus.
In some situations, one device, such as the wristband, may be used as the convenient trusted apparatus for more than one personal computing device, when that personal computing device is operated as the focal computing device.
When operating as the focal computing device in conjunction with the convenient trusted apparatus, the focal computing device is immune to keystroke sniffing spyware, because the secure web page 804 does not provide any visibility to the authentication 806 at the secure resource 800.

Since the initial filing of a patent application regarding the basic invention, the technology of commonly available personal computing devices has changed. It is now possible for the user's cell phone or tablet computer to act as a wireless router and/or WiFi hot spot. The convenient trusted apparatus may be using a communications protocol such as some form of IEEE 802.11, or a similar standard, to transmit the authentic input in one or more encrypted frames using a security protocol such as the Secure Socket Layer (SSL). These encrypted frames are now traversing the wireless router and/or WiFi hot spot. One consequence of such technological changes is that spyware intrusions into the personal computing device may include packet/frame sniffing components that may intercept packets and/or frames sent from the convenient trusted apparatus via the wireless router and/or Wifi hot spot. While some may distinguish between packets and frames, in this patent application, the term frame will apply to packets as well.

One or more of these frames can include an encrypted version of the authentic input. These frames can be sniffed and copies of them may be routed so that criminals receive such encrypted frames. Once received, computers far more powerful than a cell phone or music player may be operated to decrypt the received frames. The decryption of the frame may create a decryption of the authentic input. This leads to a real problem with very non-random passwords and authentication sequences. Suppose the authentic input is “Mary had a little lamb”. Decryption of the received frame will tend to stop when a partial result shows the conjectured authentic input has a high probability of being decrypted. Because the authentic input complies with normative symbol distributions for English, this simplifies the decryption problem, greatly reducing the cost of decryption for the criminals.

The convenient trusted apparatus may further operate a password manager configured to generate and/or maintain the authentic input as a noisy symbol sequence closely approximating random noise as a convenient password for the user. An encrypted frame does not have a high probability of matching any statistical template such as the distribution of characters or symbols in English. This means that the decryption cannot be trusted until every byte in the frame, or frames, containing the authentic input has been decrypted, which is much more expensive for the criminals.

The convenient trusted apparatus may also maintain and use two or more authentic components that collectively generate the authentic input, which is not stored on the convenient trusted apparatus. Alternatively, the convenient trusted apparatus may operate a second personal computing device as a trusted slave to maintain and use the second authentic component, so that the second authentic component is not stored in either the focal computing device or in the convenient trusted apparatus.

Further, the exact generation of the authentic input from these authentic components may only available on a secure integration node and may not stored on any combination of the user's personal computing devices. The user may operate the secure integration node and/or subscribe to a service that operates the secure integration node.

The convenient trusted apparatus may include and/or operate one secure channel interface and a second secure channel interface independent of the first secure channel interface. Alternatively, the trusted slave device may operate the second secure channel interface distinct from the convenient trusted apparatus and its operation of the first secure channel interface.

The first secure channel interface may use the local wireless router and/or hot spot. The second channel interface may not use the local wireless router and/or hot spot, if an alternative communications path is available to the convenient trusted apparatus. The convenient trusted apparatus may operate the first secure channel interface and possibly direct the trusted slave device to operate the second secure channel interface together to collectively communicate the authentic input. Alternatively, the user may direct the trusted slave device possibly without the convenient trusted apparatus knowing which personal computing device is the trusted slave deice.

Even when both the first and second secure channel interfaces must use the same wireless router and/or hot spot, as far as the virtual private networks and/or secure socket layer protocols used to deliver these frames by these two secure channel interfaces are concerned, these two channel interfaces are communicating on separate channels that are independently protected from intrusion.

Frame sniffing these communication channels does not provide a mechanism for constructing the whole of the authentic input. Even if the two authentic components can be surmised through decryption, how they are merged and altered to form the authentic input cannot be determined from the user's personal computing devices. As such, the authentic input cannot be generated from the sniffed frames.

A trusted integration node may be configured to receive the first authentic component and the second authentic component. The first authentic component is received from the frame, or frames, from the secure channel interface. The second authentic component is received from a second frame, or second frames, from the second secure channel interface.

At the trusted integration node, the decryption of the frame(s) is done by a first decryption mechanism to create the first authentic component. The decryption of the second frame(s) is done by a second decryption mechanism to create the second authentic component. The trusted integration node may include and/or operate a merge and alter mechanism configured to generate the authentic input from the first authentic component and the second authentic component. The trusted integration node then securely presents the authentic input to the secure resource to authenticate the user's access.

Through the use of the two separate encryption mechanisms, and the merge and alter mechanism, high levels of convenience and security are provided to the user. Even if both the first frame(s) and the second frame(s) are decrypted, without knowing the implementation of the merge and alter mechanism, the authentic input has not been revealed and is invisible to the focal computing device.

When the second secure channel interface avoids the router and/or hot spot used by the first secure channel interface, spyware must find the second channel to be able to sniff the second frame(s), in order to even earn the opportunity to decode the second authentic component.
The trusted integration node may be located outside the local wireline and/or wireless network containing the convenient trusted apparatus and the focal computing device.
The trusted integration node may be located as a communications component of one or more of the secure resources as and/or at an authentication portal.
The trusted integration node may be operated and/or managed by an entity other than those operating and/or managing the secure resource(s).

While the following important components may be claimed in various future patent applications based upon this document, the discussion of the following will be deferred: the memory content, its configuration, the operation of the various apparatus in response to the configured memory content, the offer, the agreement, payment request and revenue.

Other embodiments may include apparatus and methods for securing information at a point of sale, which often involves a customer, a merchant, representative and/or associate of the merchant, and one or more financial institutions such as banks and/or credit card companies. The customer as a user may need convenience. Interactions with the point of sale equipment and the user's equipment by the financial institutions may implement security that protects the user's financial information from theft and/or tampering at the point of sale, thereby reducing the merchants' and financial institutions' liabilities from such thefts.

In one implementation of these embodiments, the customer operates equipment configured to present a Private Transaction Identifier (PTN-ID) in response to an invoice presented by a Point of Sale (POS) device. The POS device is configured to generate and send a purchase request to a transaction administrator device (TAD). The TAD is configured to receive the purchase request.

The TAD accepts a transaction administrator who successfully responded to an administrator authorization. The transaction administrator initially may be a human, but over time, may be implemented as an application possibly performed by an operating system on a computer and/or finite state machine. The TAD's acceptance of the transaction administrator enables the transaction administrator to respond to the purchase request, possibly generating and possibly sending a transaction authorization and/or a transaction instruction. The transaction instruction(s) may be sent to at least one customer account to generate a payment received by a merchant account. The merchant account and/or the merchant bank on behalf of the merchant account may generate and send a payment notice to the POS device. All of these activities are performed without any financial information, such as the customer account and/or the customer bank, being received by the POS device.

A slightly more sophisticated implementation may include a transaction controller operating as the routing interface between the POS device, the TAD and possibly the customer bank and/or customer account.

A further refinement to the implementation may include a transaction domain resolver communicating with the POS device to resolve the transaction controller's routing path, possibly implemented as a Universal Resource Locator (url) that is sent to the POS device to enable its communications with the transaction controller.

Another refinement may include a transaction settlement notifier configured to receive communications from the merchant bank and/or merchant account to generate, and/or send, the payment notice to the POS device. The communications from the merchant bank and/or merchant account may then include financial information about the customer bank and/or customer account, which the transaction settlement notifier strips out in generating the payment notice.

Any combination of the transaction administration device, the transaction controller, the POS device, the transaction domain resolver and/or the transaction settlement notifier may include a configuration as previously discussed. Any combination of these may be implemented by a personal computing device, a computer and/or a finite state machine as previously discussed. The configurations may be based upon a third agreement with a communication service provider, a financial institution, and/or a resource provider. The third agreement may include a commitment for revenue by a user of one or more of these devices.

### BRIEF DESCRIPTION OF THE DRAWINGS

FIG. 1 shows a simplified diagram of the interaction of several potential components of the invention that address convenient security for the user providing an authentic input such as a password and/or user access through a convenient trusted apparatus to one or more secure resources while the user operates a personal computing device that may be infected by spyware.

FIG. 2 shows some examples of several personal computing devices the user of FIG. 1 may own, such as a cell phone, a mobile entertainment device, a tablet computer, a wearable device, for instance a smart wristband, and/or a desktop computer.

FIG. 3 shows a wireless router and/or WiFi hot spot that may be penetrated by a frame sniffer that can intercept received frame(s) and send any received frames to a criminal organization.

FIG. 4A shows the convenient trusted apparatus may include and/or operate a second secure channel interface independent of the secure channel interface that uses a local wireless router and/or hot spot. The convenient trusted apparatus may operate the secure channel interface and the second secure channel interface together to collectively communicate the authentic input while frame sniffing the frames from either one of these channel interfaces does not provide frames containing the whole of the authentic input.

FIG. 4B shows an alternative implementation including a trusted slave device 550 operated in response to a second authentic request received from the convenient trusted apparatus to send the second encrypted frame including the second authentic component through a second secure channel interface across a second secure channel to the trusted integration node of FIG. 4A.

FIG. 5 shows the trusted integration node of FIG. 4 responding to reception of the first and the second encrypted frame(s) to create the authentic input.

FIG. 6 shows the trusted integration node may include a proxy node.

FIG. 7 shows at least some examples of the apparatus may include at least one of a controller, a computer, a memory content, a form of the agreement and/or a configuration of the controller and/or the computer. The components of the apparatus may be seen through the examples of the personal computing device, the focal computing device, the convenient trusted apparatus, the convenient slave apparatus, the trusted integration node and/or the proxy node.

FIG. 8 shows some examples of embodiments for securing information at a point of sale, which often involves a customer, a merchant, or a representative and/or associate for the merchant, and one or more financial institutions such as banks and/or credit card companies.

FIG. 9A to FIG. 9C show some details of some examples of the financial information of FIG. 8.

FIG. 10 shows a simple implementation from the customer's perspective of an improved point of sale that removes the possibility of theft of the customer's financial information occurring through the point of sale device.

FIG. 11 shows a refinement of FIG. 10 that may include a transaction controller and/or a transaction domain resolver and/or a settlement notifier.

And FIG. 12 shows at least some examples of the apparatus may include at least one of a controller, a computer, a memory content, a form of a third agreement and/or a configuration of the controller and/or the computer. The components of the apparatus may be seen through the examples of the transaction administration device, the customer equipment, the POS device, the transaction controller, the transaction domain resolver, and/or the settlement notifier and/or the personal computing device.

### DETAILED DESCRIPTION OF THE DRAWINGS

One aspect of this invention at least partly solves the technical problem of conveniently maintaining and/or providing security for one or more users 10. As used herein, providing convenient security includes denying spyware 350 visibility to authentic input 514 while supplying that authentic input to secure resources 800 the user wishes to use and/or access. This prevents a keystroke sniffer 352 from being able to capture that authentic input. In some implementations, this is done without any authentication 806 being visible or performed by the focal computing device.

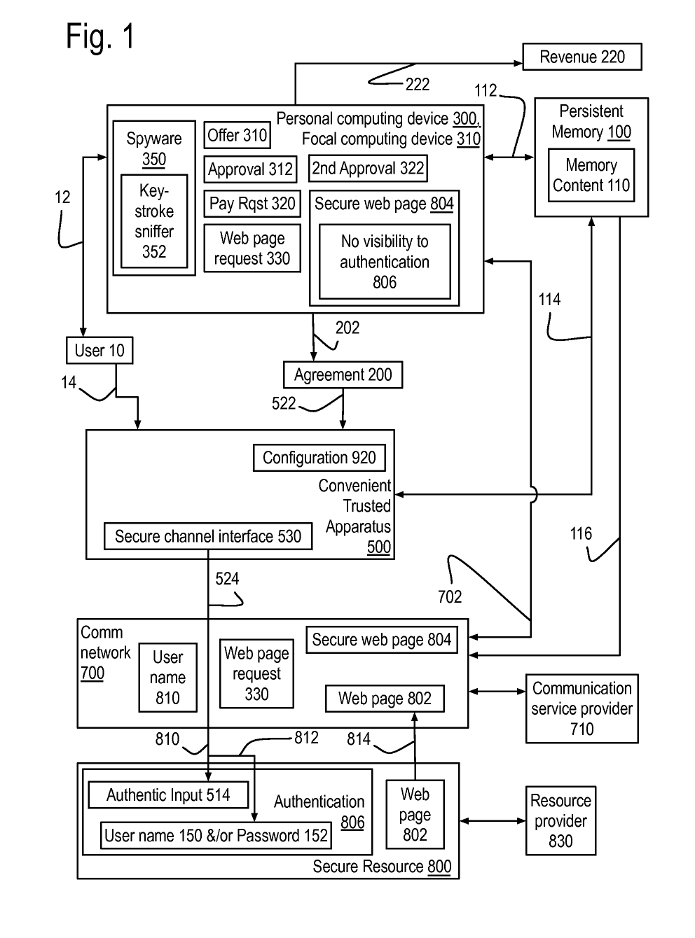

Embodiments of this invention for convenient user security for input of access credentials and/or authorizations such as passwords and/or user access to various secure resources 800 are first discussed with FIG. 1.

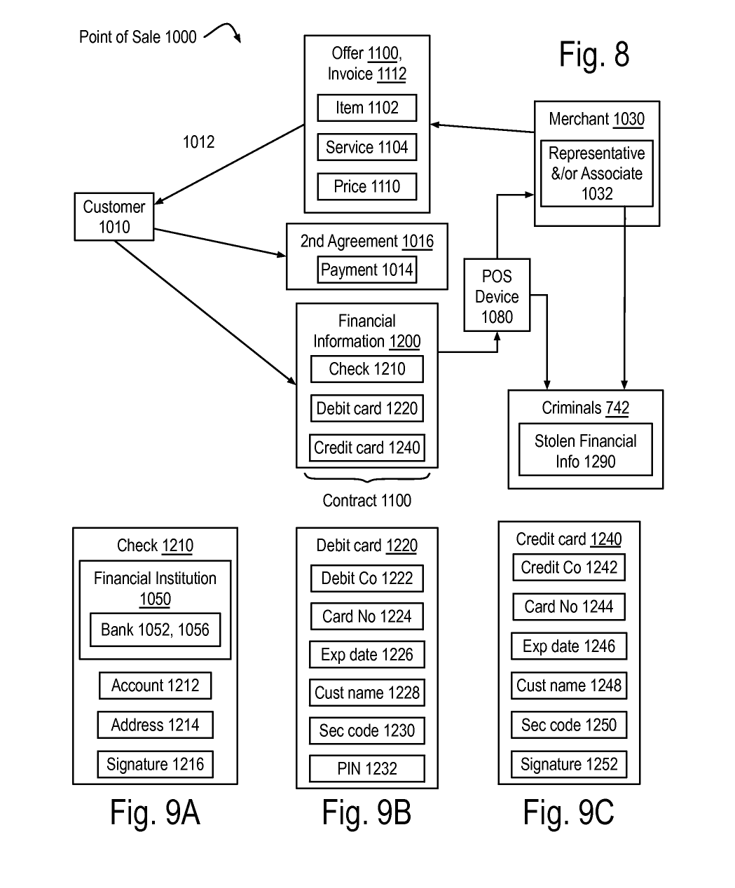

Embodiments for securing information at a point of sale, which often involves a customer, a merchant, or representative for the merchant, and one or more financial institutions such as banks and/or credit card companies are first discussed with FIG. 8.

To clarify this disclosure, reference numbers are used only once in a paragraph. From here on, the first time a referenced item is used, it will typically be used with its reference number(s).

As used herein, the authentication 806 is based upon an authentic input 514 delivered to a secure resource 800. Authentication may include a user name 150 and/or a password 152 that may include one or more instances of the authentic input.

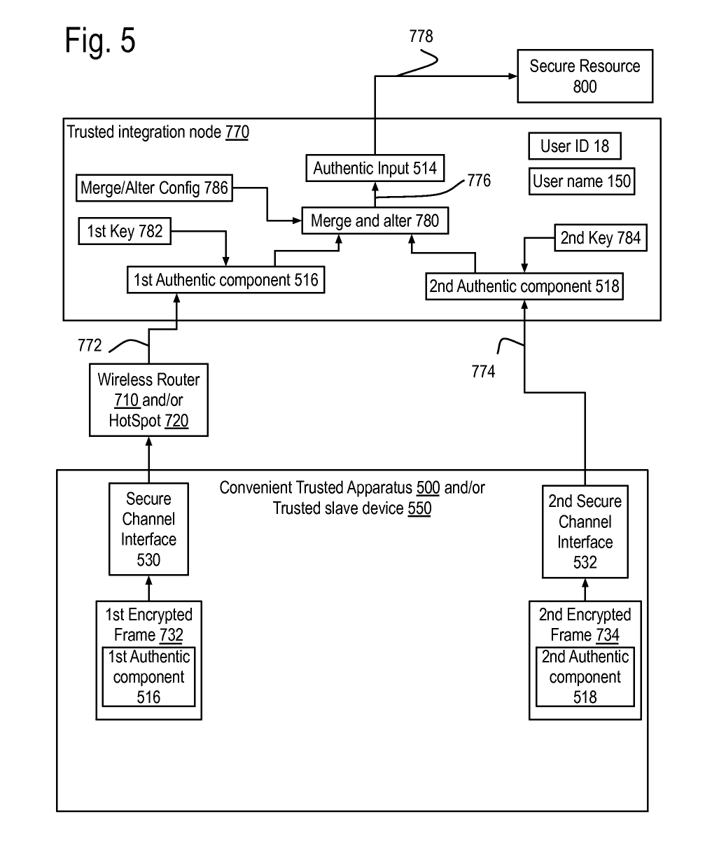

FIG. 1 shows a simplified diagram of the interaction of several potential components of the invention that address convenient security for the user 10 providing access credentials based upon authentic input 514 access to one or more secure resources 800, for example, a secure transaction processor. The user 10 may operate 12 a personal computing device 300 as a focal computing device 310 as well as operate 14 a convenient trusted apparatus 500. The user in operating the focal computing device, requests access of the secure resource by requesting 330 a web page 802. The secure resource responds to the request 330 by providing the web page. In some implementations, the web page may altered to create the secure web page 804. In other implementations, the secure resource may store and provide the secure web page as a default response to the request 330.
Most of the time, the authentic input 514 will be used to represent these access credentials, such as the user name 150 and/or a user identification 18 as shown in FIG. 5. This has been done to clarify the operation of the invention. This simplification is not meant to limit the scope of the patent. In some embodiments, more of the access credentials may be presented in a fashion as disclosed for the authentic input. In at least some implementations any authentication is not visible to the focal computing device 310.
The convenient trusted apparatus 500 may respond to the user 10 directions 14 by causing 812 a user name 150 being provided to the secure resource 800. The user name may be sent across the communications network 700 to the secure resource in some situations.
The convenient trusted apparatus 500 may respond to the user 10 directions 14 indicating a request for the authentic input 514, to which the convenient trusted apparatus 500 responds by sending the authentic input to the secure resource while the convenient trusted apparatus sends nothing whatsoever to the focal computing device 310 thereby rendering spyware 350 unable to derive that authentic input from its keystroke sniffer 352.

As used herein, a focal computing device 310 refers to a personal computing device 300 directed 12, possibly by a user 10, to access a secure resource 800. The spyware 350 refers to a configuration of the focal computing device to possibly operate at least a keystroke sniffer 352 to attempt to capture and send the authentic input 514 to a criminal or criminal organization 542 as shown in FIG. 3. However, this is thwarted by the operation of the convenient trusted apparatus 500, which provides the focal computing device 310 with no relevant input whatsoever to the authentication 806 for the user's access of the secure resource 800.

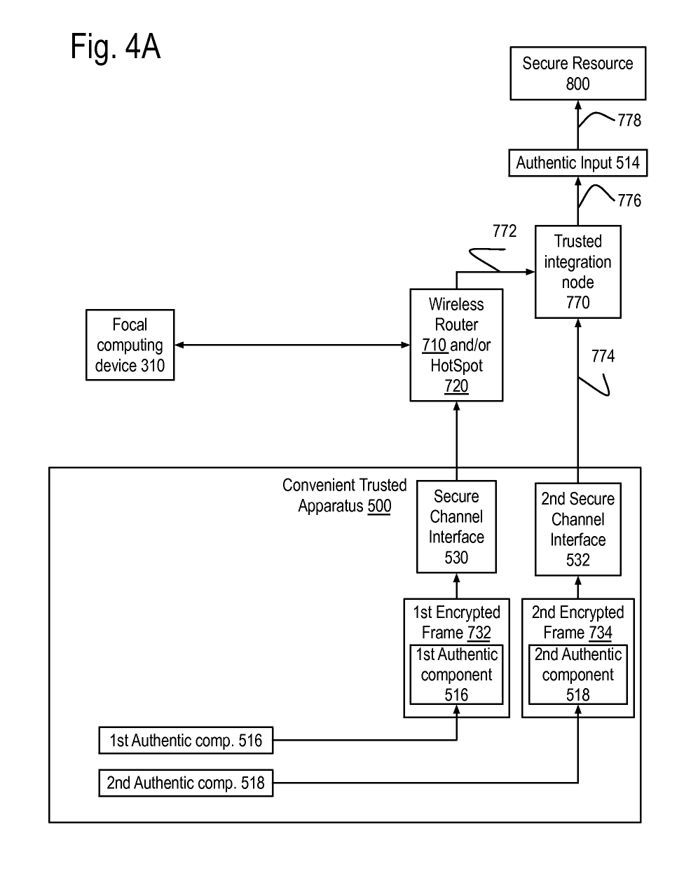

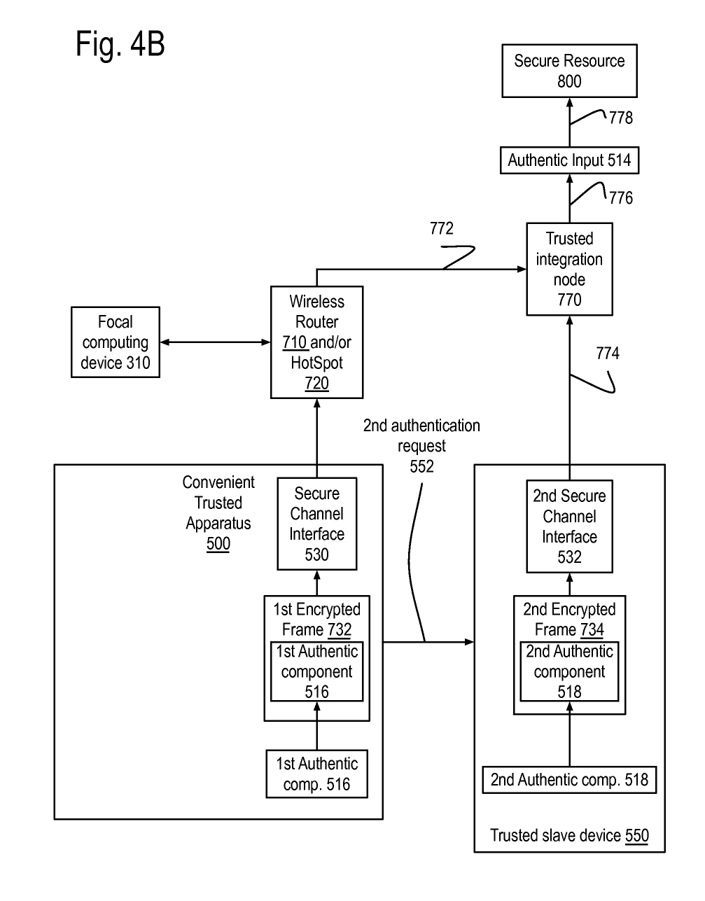

The apparatus may include at least one of the following: a memory content 110 residing in a persistent memory 100, a personal computing device 300 configured to present an offer 310 for approval 312 by a user 10 to create an agreement 200 that configures the memory content, the personal computing device configured to present a payment request 320 for a second approval 322 to create a revenue 220 from the personal computing device based upon the configured memory content 110, a convenient trusted apparatus 500 and/or the trusted integration node 770. With the exception of the trusted integration node 770, the other referenced elements of this paragraph are shown in FIG. 1. The trusted integration node 770 will be discussed starting in FIG. 4.

FIG. 1 will now be discussed in terms of the user 10 operating 12 the personal computing device 300 before its configuration as the focal computing device 310 and its interaction with the convenient trusted apparatus 500. The personal computing device 300 may be configured to present an offer 310, preferably to the user 10 operating 12 the personal computing device. The personal computing device may be configured to respond to the user's response of approval 312 to the offer 310 to create the agreement 200. The agreement 200 may reside in the persistent memory 100, the memory content 110, the personal computing device and/or the communications network 700. The personal computing device may further be configured to present a payment request 320 on the personal computing device to the user 10 operating 12 the personal computing device to create a revenue 220 from 222 the personal computing device based upon the memory content 110.
By way of example, the revenue 220 may be in the form of a transfer request from a secure resource 800, such as a financial institution to an entity providing access by the personal computing device 300 to the communications network 700.
Another example, the revenue 220 may result from 222 the personal computing device 300 making a payment request 320 to setup an automatic payment for the use 14 of the convenient trusted apparatus 500 by the user 10
Another example, the revenue 220 may result from 222 a payment request 320 for a subscription to an application service for the personal computing device 300 to interact with the convenient trusted apparatus 500 to hide the visibility, thereby make invisible 524, the authentic input 514 within the personal computing device.

FIG. 1 will now be discussed in terms of the agreement 200 having been created and any financial commitments generated by the second approval 322 having been met. The operation of the invention may include at least one and/or any combination of the following:
The communications network 700 and/or the convenient trusted apparatus 500 and/or the personal computing device 300 may be operated in response to the memory content 110 residing in the persistent memory 100.
The personal computing device 300 may present the offer 310 for approval 312 to create the agreement 200.
The personal computing device 300 may present the payment request 320 for the second approval 322 to create the revenue 220. The revenue may originate from the personal computing device, even though the destination of the revenue may or may not be in the United States. The payment request may be based upon the memory content 110.
The personal computing device 300 may respond to the agreement 200 by being configured to act as the focal computing device 310.

The convenient trusted apparatus 500 may include a personal computing device interface 600 configured to support communication between the convenient trusted apparatus and the personal computing device 300 now configured as the focal computing device 310. The convenient trusted apparatus may also be configured to communicate the authentic input 514 across the communications network 700 to the secure resource 800, again in response to the agreement 200 and the receipt by the focal computing device of the Secure Web Page 804.

The convenient trusted apparatus 500 provides the user 10 with convenient security for authentic input 514 such as passwords and/or other authentication to one or more secure resources 800. One convenient trusted apparatus may include a convenient trusted apparatus identification presented at a secure channel interface 530 as to engage in communication based upon the agreement 200 between a communication service provider 710 and the manager of the convenient trusted apparatus.
The agreement 200 may commit the communication service provider 710 to support the communication across the secure channel interface 530 based upon the manager agreeing to pay the communication service provider a revenue 220.
The agreement commits the manager (and/or an organization the manager represents) to pay the communication service provider 710 in exchange for that communication across the secure channel interface 530.
Note that in some situations, the organization may include a family and the manager may be a family member.

As used herein, a personal computing device 300 may be configured to operate a spreadsheet, a word processor, a web browser and may be further configured to act as a telephone and/or a camera and/or a wireless sensor.

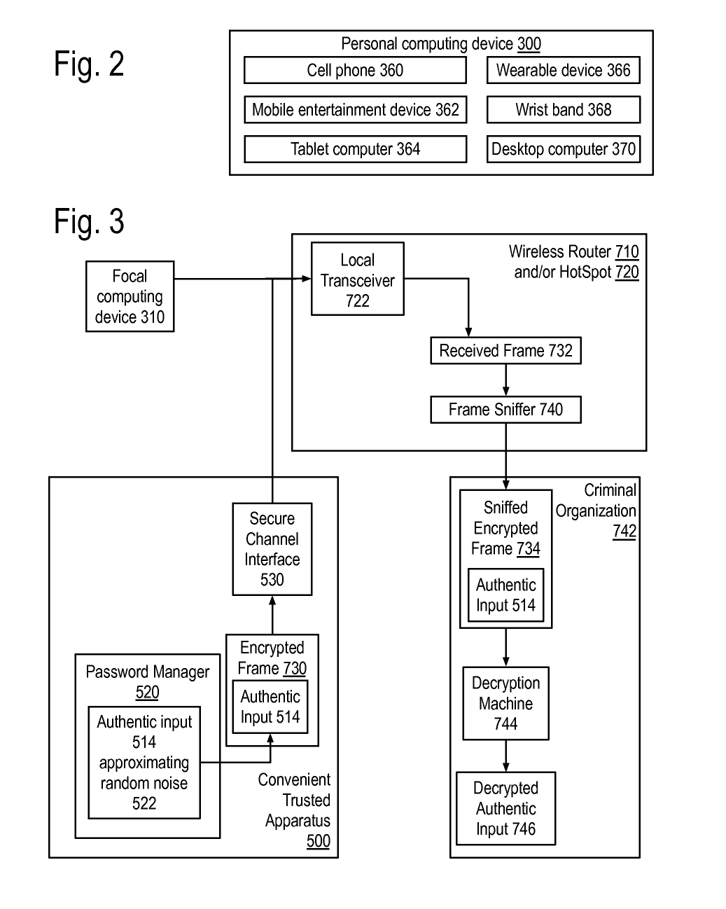

FIG. 2 shows some examples of several personal computing devices 300 the user 10 of FIG. 1 may own, such as a cell phone 360, a mobile entertainment device 362, a tablet computer 364, a wearable device 366, for instance a smart wristband 368, and/or a desktop computer 370.
When the user 10 is using the tablet computer 364 as the focal computing device 310 for secured transactions, the cell phone 360 may operate as the convenient trusted apparatus 500.
When the user 10 is operating a web browser on the cell phone 360, making the cell phone the focal computing device 310, the wristband 368 may operate as the convenient trusted apparatus 500.
In some situations, one device, such as the wristband 368 may be used as the convenient trusted apparatus 500 for more than one personal computing device 300, when that device is operated as the focal computing device 310.
When operating as the focal computing device 310 in conjunction with the convenient trusted apparatus 500, the focal computing device is immune to keystroke sniffing 352 spyware 350, because the authentic input 514 is never available for keystroke sniffing 352.

Alternatively, one of the convenient trusted apparatus 500 may be configured to interact with personal computing devices operated by more than one user. For example, suppose a couple of people are traveling. They may both use the same convenient trusted apparatus 500. Each member of the couple may operate as a separate user 10 with one or more personal computing devices 300 as their focal computing device 310 and the same convenient trusted apparatus.

FIG. 3 shows a wireless router 710 and/or WiFi hot spot 720 that may be penetrated by a frame sniffer 740 that can intercept received frame(s) 732 and send any received frames to a criminal organization 742.
The frame sniffer 740 may intercept the encrypted frame(s) 730 as received frames 732 and send these received frames to a criminal organization 742 to create sniffed encrypted frames 730 containing the authentic input 514. The criminal organization may operate a decryption machine 744 to generate a decryption of the authentic input 514. The decrypted authentic frame may be able to replace the authentic input 514 to authenticate access to the secure resource 800 creating a lucrative opportunity for the criminal organization to steal from the law abiding users 10 of FIG. 1.
Suppose the authentic input 514 is “Mary had a little lamb”. Decryption of the sniffed frame 734 will tend to stop when a partial result shows the conjectured authentic input has a high probability of being decrypted. Because the authentic input complies with normative symbol distributions for English, this simplifies the decryption problem, greatly reducing the cost of decryption 744 for the criminal organization 742. As used herein, a criminal organization may include one or more criminals operating at least one computer to steal, impersonate and/or defraud one or more user(s) 10. Commonly used components of html forms, such as “username” and “password” already provide criminals known character sequences that are common in SSL encrypted streams.
The convenient trusted apparatus 500 may further operate a password manager 520 configured to generate and/or maintain the authentic input 514 closely approximating random noise 522 as a convenient password for the user 10. An encrypted frame 730 does not have a high probability of matching any statistical template such as the distribution of characters or symbols in English. This means that the decryption 746 cannot be trusted, which is much more expensive for the criminals 742.
The wireless router 710 and/or Wifi hotspot 720 may be included in one or more personal computing device 300 shown in FIG. 2. The frame sniffer 740 may be part of spyware 350 in the personal computing device 300 as shown in FIG. 1.

The convenient trusted apparatus 500 may be using a communications protocol such as some form of IEEE 802.11, or a similar standard, to transmit the authentic input 514 in one or more encrypted frames 730 using a security protocol such as the Secure Socket Layer (SSL). While some may distinguish between packets and frames, in this patent application, the term frame will apply to packets as well.

As used herein, a virtual private network (VPN) extends a private network across a public network, such as the Internet possibly implemented as a communications network 700. The VPN access process may provide a VPN portal with access credentials to enable communication across the VPN. For example, the access credentials may include a user name and a password possibly as the authentic input 514. The access credentials may be generated by an interaction with a Secure Data Store and possibly interactions with a user interface. VPN management process may be aware of eligible VPN services and/or usage contexts for the VPN. The VPN management may establish connection with the VPN and locally authenticate the correctness of the user 10.
For example, the VPN Management process relevant to the US Patent and Trademark Office is aware of the registered and non-registered capabilities of client computers attempting to access and use its VPN and public services.
For example, it is a public service to access the text and drawings of any published patent application and its file history. It is a VPN service to access the text and drawings of patent application that have been published by only a subset of the VPN clients who represent patent practitioners, such as patent agents, patent attorneys and their legal staff.

FIG. 4A shows the convenient trusted apparatus 500 may include and/or operate a second secure channel interface 532 independent of the secure channel interface 530 that uses a local wireless router 710 and/or hot spot 720. The convenient trusted apparatus may operate the secure channel interface 530 and the second secure channel interface 532 together to collectively communicate the authentic input 514 while frame sniffing the frames from either one of these channel interfaces does not provide frames containing the whole of the authentic input. The frame or frames 732 from the secure channel interface 530 may deliver a first authentic component 516. The second frame or second frames 734 from the second secure channel interface 532 may deliver a second authentic component 518. The first authentic component and the second authentic component collectively deliver the authentic input 514. However, in some implementations, the authentic input 514 may not be stored in the format the secure resource 800 requires. Instead the authentic input 514 may be stored within the convenient trusted apparatus 500 as the first authentic component 516 and the second authentic component 518, which collectively do not imply the authentic input. Thus spyware 350 inserted into the convenient trusted apparatus cannot be simplistically used to determine the authentic input.

The secure channel interface 530 may communicate with a wireless router 710 and/or hotspot 720 to deliver the first encrypted frame(s) 732 containing the first authentic component 516 through a first portal 772 to a trusted integration node 770. The second secure channel interface 532 may skip communication with the wireless router 710 and skip communication with a hotspot 720 to deliver a second encrypted frame(s) 734 to the trusted integration node 770. The trusted integration node may respond to receiving the first encypted frame(s) 732 and the second encrypted frame(s) 734 to create the authentic input 514. The authentic input may be sent to the secure resource 800 to authenticate the user 10 of FIG. 1. This authentication permits the user operating the focal computing device 310 to access the secure resource and/or secure transaction processor.

FIG. 4B shows an alternative implementation including a trusted slave device 550 operated in response to a second authentic request received from the convenient trusted apparatus 500 to send the second encrypted frame 734 including the second authentic component 518 through a second secure channel interface 532 across a second secure channel 774 to the trusted integration node 770.

Alternatively, rather than a second authentication request 552 being sent from the convenient trusted apparatus 500, the user 10 may provide the second authentication request to the trusted slave device 550.

FIG. 5 shows the trusted integration node 770 of FIG. 4 responding to reception of the first encypted frame(s) 732 and the second encrypted frame(s) 734 to create the authentic input 514. The first encrypted frame(s) may be decrypted using a first key 782 and the first authentic component 516 may be created. The second encrypted frame(s) may also be decrypted using a second key 784 to create the second authentic component 518. A merge and alter circuit 780 may respond to a merge/alter configuration 786, the first authentic component and the second authentic component to create the authentic input 514. The authentic input may then be presented to the secure resource 800 to authenticate the user 10.

The user 10 may be identified within the trusted integration node 770 through a user identification 18, which may be used, possibly in conjunction with the specific secure resource 800 to determine first key 782, the second key 784 and/or the merge/alter configuration 786. The first key and the second key may direct two separate decryption mechanisms. Alternatively, the first key and the second key may direct a single decryption mechanism. The automation of the trusted integration node combined with the convenient trusted apparatus provide a new level of convenience and security to the user 10. The user does not need to spend their time and effort on such things. Even if both of frame(s) and the second frame(s) are decrypted, without knowing the implementation of the merge and alter mechanism, the authentic input has not been revealed.

FIG. 5 also shows an alternative embodiment of the convenient trusted apparatus where the authentic input 514 stimulates a secure component generator 560 to generate the first authentic component 516 and the second authentic component 518. While this implementation of the convenient trusted apparatus may be less secure than the implementation shown in FIG. 4A and/or FIG. 4B, it is within the scope of this invention and its potential claims.

The second secure channel interface 532 thwarts spyware 350 because the criminal(s) 742 have no chance of retrieving the entirety of the authentic input 514 by intrusion of the frame sniffer 740 into the wireless router 710 and/or hotspot 720. Even assuming both encrypted frames 732 and 734 are sniffed and the first authentic component 516 and the second authentic component 518 are decrypted, the criminal organization 742 does not know how to merge and alter these components to create the successfully decrypted authentic input 746.

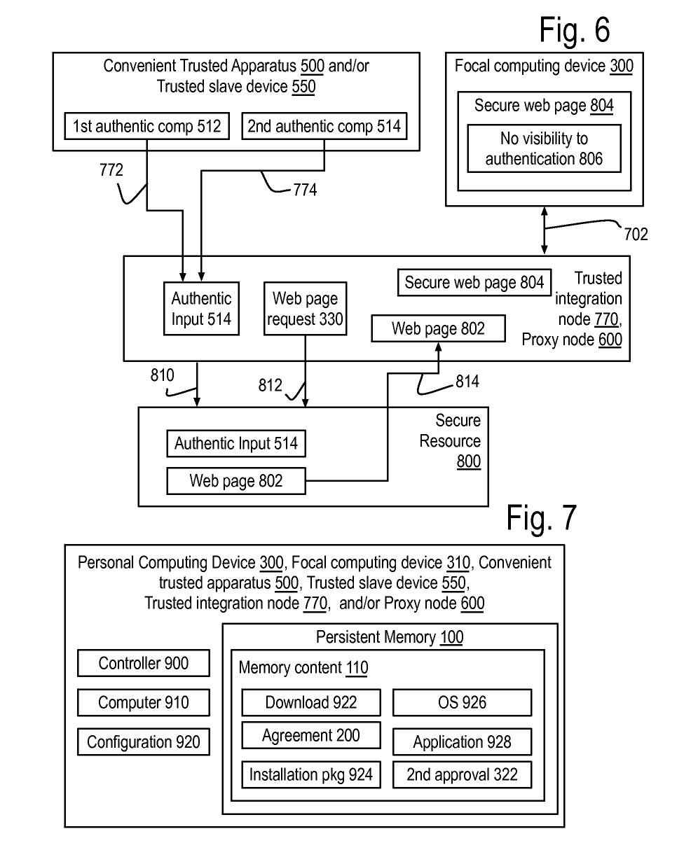

FIG. 6 shows the trusted integration node 770 may include a proxy node 600. The proxy node may be configured to receive the web page 330 as shown in FIG. 1. The proxy node may receive the web page 802 from the secure resource 800 in response to the web page request. The web page may altered to create an secure web page containing no visibility to the authentication 806 at the secure resource 800.
The trusted integration node 770 may be located outside the local wireline and/or wireless network containing the convenient trusted apparatus 500 and the focal computing device 310.
The trusted integration node 770 may be used as a communications component of one or more of the secure resources 800, possibly as an authentication portal.
The trusted integration node 770 may be operated and/or managed by an entity other than those operating and/or managing the secure resource(s) 800.

Communication across the secure channel interface 530, the second secure channel interface 532 and/or the personal computing device interface 520, may employ one or more communications protocols that may involve one or more wireline and/or wireless physical transports.

Examples of communications protocols that support wireless physical transports include, but are not limited to, Bluetooth, IEEE 815 and/or 811 communications standards. Such communication standards may employ one or more of the following modulation/demodulation approaches: amplitude modulation (AM), frequency modulation (FM), phase modulation, and/or multiple-access approaches. Multiple-access approaches may include, but are not limited to, any combination of implementations of one or more of the following: time division multiple access, code division multiple access, orthogonal frequency division multiplexing, frequency hopping and/or time hopping.

Examples of wireline physical transports include twisted pair, metallic ribbon cable, optical fiber, optical fiber ribbon cable, Universal Serial Bus (USB) couplings, and/or hinges that may mechanically and communicatively couple two components, such as a keyboard cover and a tablet computer.

FIG. 7 shows at least some examples of the apparatus may include at least one of a controller 900, a computer 910, a memory content 110, a form of the agreement 200 and/or a configuration 920 of the controller and/or the computer. The components of the apparatus may be seen through the examples of the personal computing device 300, the focal computing device 310, the convenient trusted apparatus 500, the convenient slave apparatus 550, the trusted integration node 770 and/or the proxy node 600.

The agreement 200 may produce a download onto a communications device and/or a personal computing device 300 to configure one or both of these devices to perform process steps in accord with various embodiments of the convenient trusted apparatus 500 and/or the convenient slave apparatus 550. Consider the following examples:
A cell phone 360 and a tablet computer 364 may be configured so that the cell phone will act as a convenient trusted apparatus 500 for the tablet computer as the focal computing device 310.
A wifi hotspot 720 and a desktop computer 370 may be configured so that the wifi hotspot operates as a convenient trusted apparatus 500 interacting with the desktop computer as the focal computing device 310.
A communications network 700 may be configured to host and/or implement the trusted integration node 770 and/or the proxy node 600 interacting with the convenient trusted apparatus 500 and the focal computing device 310 operated by the user 10.

The controller 900 may include at least one input, at least one output, and possibly at least one internal state. The controller may respond to the input by altering the internal state. The controller may generate the output based upon at least one value of the input and/or at least one value of at least one of the internal states. The internal state may implement one or more instances of the persistent memory 100, the memory contents 110, and/or the configuration 920.

The computer 910 includes at least one instruction processor and at least one data processor. Each of the data processors is instructed by at least one of the instruction processors. The computer may implement one or more instances of the persistent memory 100, the memory content 110, and/or the configuration 920.

The memory content 110 may be retained in a persistent memory 100, the controller 910 and/or the computer 920. As used herein, the memory content 110 may include any combination of any number of instances of any of the following: a download 922, an installation package 924 configured to implement at least part of an operating system 926, and/or an application 928 configured to interact with the operating system, the operating system, the application, the agreement 200 and/or a revenue commitment shown as the second approval 322 in FIG. 1, based upon one or more of the preceding memory contents.

The download 922 and/or the installation package 924, the operating system 926 and/or the application 928 may be a product of the agreement 200 and/or the revenue commitment shown as the second approval 322.

The persistent memory 100 may include a non-volatile memory component and/or may operate as an essentially non-volatile memory through the use of battery backup to power the persistent memory. As such the memory contents are tangible, being able to persist indefinitely.

FIG. 8 shows some examples of embodiments for securing information at a point of sale 1000, which often involves a customer 1010, a merchant 1030, or a representative and/or associate 1032 for the merchant, and one or more financial institutions 1050 such as banks 1052 and/or credit card companies 1054.

A number of terms will be used in this document that refer to specific meanings.

The Point of Sale (POS) 1000 in its simplest form will refer to a situation where the merchant 1030 offers 1100 one or more items 1102 and/or services 1104 to the customer 1010 at a price 1110 and the customer responds 1012 to the offer by agreeing 1016 to pay 1014 the price 1110 to form a contract 1100 by using a point of sale device 1080. An invoice 1112 will refer to the offered item(s) 1102 and/or service(s) 1104 and the price 1110. The agreement 1016 of this and subsequent Figures does not refer the agreement of preceding Figures and will be referred to as a second agreement hereafter.

The contract 1100 may refer to the invoice 1112 offered 1100 by the merchant 1030 and second agreement 1016 of the customer 1010 to pay the price 1110, in return for the merchant's commitment to deliver the items 1102 and/or perform the services 1104.

Frequently, the contract 1100 is executed at the POS 1000 by the merchant 1030 receiving financial information 1200 from the customer 1010 to execute the payment 1014.

The financial information 1200 may include, but is not limited to, any combination of a check 1210, a debit card 1220, and/or a credit card 1240 being offered 1014 by the customer 1010. The point of sale device 1080 may be used by the merchant 1030, the merchant's representative and/or associate 1032 to enter the financial information from the check, debit card and/or credit card to complete the contract 1100. In many situations, it is this point of sale device that is intruded by the criminals 742 to create stolen financial information 1290 that is then used for criminal purposes.

A financial institution 1050 will refer to any organization, company, corporation, partnership, credit union, or other entity that may be instructed by the customer 1010 to pay the price 1110 of the invoice 1112. More than one financial institution may be available for the customer to select to create the payment. These financial institutions are often the parties most adversely affected by the theft of financial information 1200 given by the customer to the merchant 1030 in a POS 1000 situation, because the financial institutions often pay back the customers for the lost funds due to the theft 1290 of financial information.

FIG. 9A to FIG. 9C show some details of some examples of the financial information 1200 of FIG. 8.
FIG. 9A shows the check 1210 typically identifies a bank 1052, referred to as the customer bank 1056, a bank account 1212, often the billing address 1214 and signature 1216 of the customer 1010.
FIG. 9B shows the debit card 1220 typically identifies a debit card company 1222 (often a bank 1052), a card number 1224, an expiration date 1226, the customer name 1228 as used for that debit card, often with a security code 1230 placed on the “back side” of the debit card. The customer 1010 must often give a Personal Identification Number 1232 to use the debit card.
FIG. 9C shows the credit card (CC) 1240 typically identifies a credit card company 1242, a card number 1244, an expiration date 1246, the customer name 1248 as used for that debit card, often with a security code 1250 placed on the “back side” of the credit card as well as a signature 1252.

Unfortunately, this is when and where many problems begin in terms of loss of the security of the customer's 1010 financial information 1200 through the use of these typical payment mechanisms.
Using the check 1210 gives the merchant 1030 and those associated 1032 with the merchant a piece of paper identifying the customer bank 1056, the customer bank account 1212, the billing address 1214 and the signature 1216 of the customer 1010. The point of sale device 1080 may scan the check enabling the criminals 742 to create the stolen financial information 1290.
Using the debit card 1220 often requires the customer 1010 enter or present a Personal Identification Number (PIN) 1232 to verify authorization to use the debit card. So in paying the invoice 1112, the customer has given the merchant 1030 and/or their associates 1032 and/or the point of sale device 1080, the PIN, the debit card company 1222, the card number 1224, the expiration date 1226, the customer name 1228 as used for that card, as well as the security code 1230.
Using the credit card 1240 often requires the customer 1010 to sign something as a signature 1252 to verify authorization to use the credit card. So in paying the invoice 1112, the customer has given the merchant 1030 and/or their associates 1032 and/or the point of sale device 1080, their signature, the credit card company 1242, the card number 1244, the expiration date 1246, the customer name 1248 as used for that card, as well as the security code 1250 and the signature 1252.
Each of these standard payment methods has revealed enough financial information 1200 about the customer 1010 to allow criminals 742 to steal money from the customer's bank 1052 and/or the credit card company 1054, based upon the stolen financial information 1290.
While some of these financial information 1200 devices, in particular the debit card 1220 and/or the credit card 1240, may encrypt some part of their financial information 1200, such encryption can be penetrated. Customers 1010, merchants 1030 and financial institutions 1050 such as banks 1052 could one day find all their encrypted financial information 1200 passing through point of sale devices 1080 decrypted by criminals 742 to create stolen financial information 1290, thereby wreaking havoc on these pillars of the world's economy.

Some of the technical problems being solved in this embodiment:
A first basic technical problem: how can a retail customer 1010 at a point of sale 1000, authorize payment 1014 from their financial institution 1050 to the merchant 1030 without divulging their financial information 1200 to that merchant or any of the merchant's affiliates 1032.
A second basic technical problem: how to efficiently solicit and incorporate direction from one or more designated administrators during a point-of-sale 1000 payment 1014 process. Here are some examples: A parent may wish to authorize expenditures above a certain threshold for charges incurred by their children. A business may wish to enforce a policy requiring at least two company officers to sign off on certain corporate expenses.
A third basic technical problem: how to readily delegate authorization responsibility in a manner that is targeted, audit-able, and easily revoked when that is required. For example: recurring low-value transactions might be designated eligible for automated approval, but simultaneously subject to real-time oversight for quota compliance.

The customer 1010 may be a user 10 of personal computing devices 300 needing convenience. Interactions with the point of sale 1000 equipment 1080 and the user's 1010 equipment 1300 with the financial institutions 1050 may implement security that protects the consumer's financial information 1200 from theft 1290 at the point of sale device 1080, thereby reducing the merchants' 1030 and financial institutions' 1050 liabilities from such thefts.

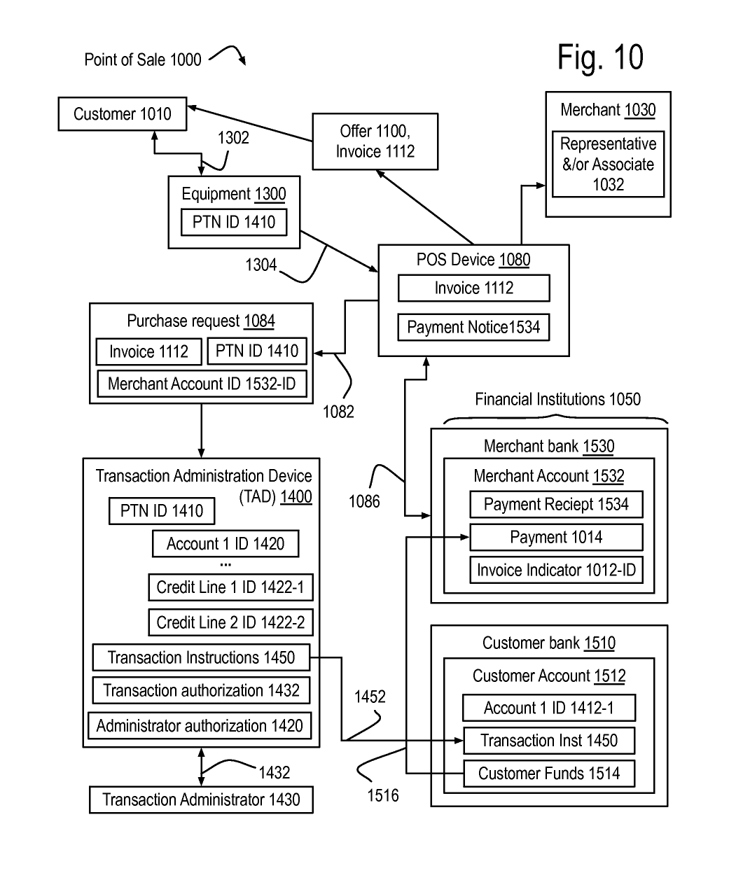

FIG. 10 shows a simple implementation from the customer's 1010 perspective of an improved point of sale 1000 that removes the possibility of theft 1290 of the customer's financial information 1200 occurring through the point of sale device 1080. The customer operates equipment 1300 configured to present a Private Transaction Identifier (PTN ID) 1410 in response to an invoice 1112 or offer 1110 by the merchant 1030, the representative and/or associate 1032 as presented by a Point of Sale (POS) device 1080. The POS device is configured to generate and/or send 1086 a purchase request 1084 to a transaction administrator device (TAD) 1400. The purchase request may include the invoice, PTN ID and a identification 1532-ID of a merchant account 1532, possibly including an indication of the merchant's bank 1530. The TAD is configured to receive the purchase request and through the interaction 1432 of a transaction administrator 1430 possibly authorize 1420 the transaction, possibly generating and/or issuing 1452 transaction instructions 1450 to the customer's bank 1510 regarding one or more customer accounts 1512. the customer bank responds to the transaction instructions by making the payment 1014 from the customer funds 1514 into the merchant's account to which the merchant's bank responds by generating and sending 1088 a payment notice 1534 which references the receipt of payment by the merchant's account based upon the invoice and PTN ID, without disclosing any of the customer's financial information 1200 at the POS device.

The point of sale device 1080 never receives the customer's 1010 financial information 1200, therefore cannot reveal it to criminals 742, and thus, cannot be responsible for its theft, nor can the merchant 1030 nor the financial institution(s) 1050 that may be involved in the transaction.

As before in FIG. 8, the customer 1010 is presented an offer 1100, possibly represented as an invoice 1112 by the merchant 1030, their representative and/or associate 1032.

The customer equipment 1300 may be a card that may include a magnetically encoded strip containing the PTN ID 1410. Alternatively, the customer equipment may include a Radio Frequency Identification (RF ID) mechanism that contains and sends the PTN ID. The customer equipment may include a biometric identification device to identify the customer 1010.

The TAD 1400 accepts a transaction administrator 1430 who successfully responded to an administrator authorization 1420. The transaction administrator initially may be a human, but over time, may be implemented as a second application 1928 possibly performed by an operating system 926 on a computer 900 and/or controller 910 as shown in FIG. UHU05. The TAD's acceptance of the transaction administrator enables the transaction administrator to respond to the purchase request 1092, possibly generating and possibly sending a transaction authorization 1432 and/or a transaction instruction 1450. The TAD may be operated by the transaction administrator to make decisions based upon the status of various accounts identified 1412-1 in such a fashion that the POS device 1080 cannot determine which financial institution 1050 is being used to transfer 1516 customer funds 1514 to make the payment 1014 in the merchant's account 1532.

The merchant's bank 1530 may generates a payment receipt 1532 in response to receiving the payment 1014 and acknowledges an invoice indicator 1012. This payment receipt may be used to generate and/or send a payment notice 1534 to the POS Device 1080 signifying the honoring of the payment of the offer 1100 and/or invoice 1112 by the customer 1010 without the POS device ever containing any financial information 1200 about the customer.

In some situations, the transaction administrator 1430 may be the customer 1010. The customer may be operating 1432 a personal computing device 300 configured as the transaction administration device 1400. In other situations, the transaction administrator may be removed from the customer, possibly a comptroller for a company, or parent in a family who manages payments for the relevant organization. In many implementations the transaction administrator may need to successfully respond to an administrator authorization 1420 in order to be authorized to receive payment requests 1082, generate and send transaction instructions 1450 and/or transaction authorizations 1432.

In some situations, the transaction administration device 1400 may be operating using classic encryption technologies such as virtual private networks and/or secure socket layers. Alternatively, the transaction administration device may operate using quantum entangled encryption across otherwise classic communications channels.

As used herein, quantum entanglement will refer to an entangled system. The entangled system has a quantum state that cannot be factored as a product of states of its local constituents (e.g. individual particles). If entangled, one constituent cannot be fully described without considering the other(s). Note that the state of a composite system is always expressible as a sum of products of states of local constituents; it is entangled if this sum always has more than one term. One of these terms may be local to a device, such as the transaction administration device 1400 and the other term to a more distant device, such as the customer's bank 1510 and/or the customer's account 1512.

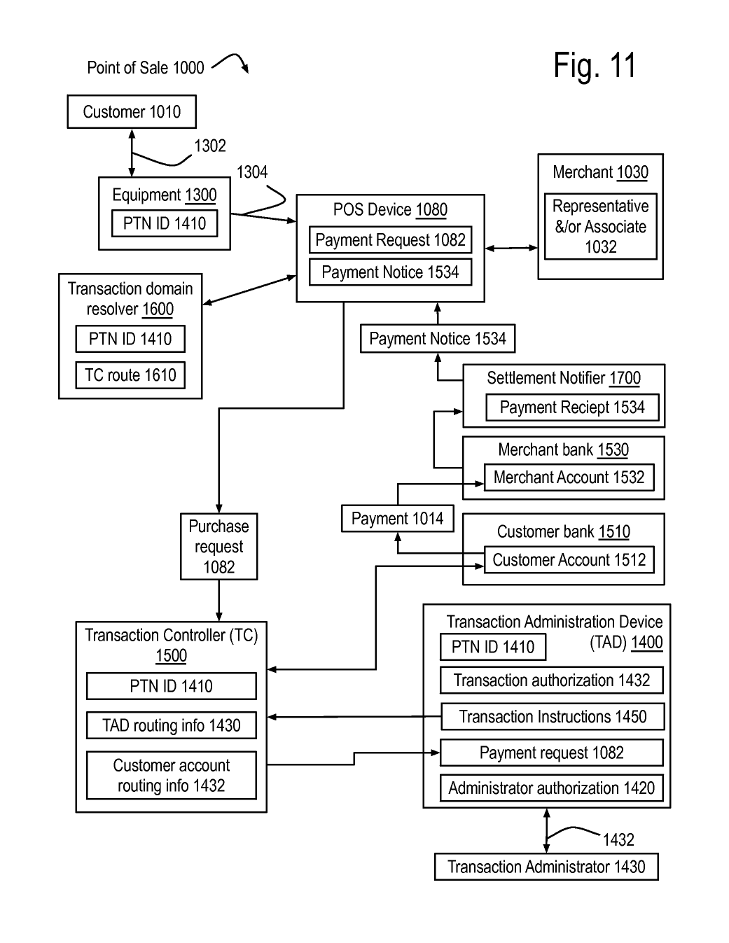

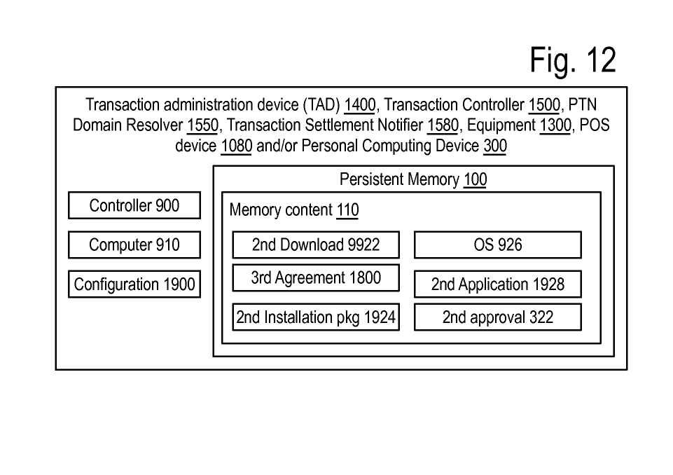

FIG. 11 shows a refinement of FIG. 10 that may include a transaction controller 1500 and/or a transaction domain resolver 1600 and/or a settlement notifier 1700. The transaction controller may operate as a routing interface between the POS device 1080, the TAD 1400 and possibly the customer bank 1510 and/or the merchant bank 1530. The transaction domain resolver may communicate with the POS device to resolve the transaction controller's routing path, possibly implemented as a Universal Resource Locator (url) that is sent to the POS device to enable its communications with the transaction controller based upon the PTN ID 1410. The transaction settlement notifier may be configured to receive communications from the merchant bank and/or merchant account 1532 to generate, and/or send, the payment notice 1534 to the POS device. The communications from the merchant bank and/or merchant account may then include financial information about the customer bank and/or customer account, which the transaction settlement notifier strips out in generating the payment notice.

FIG. 12 shows at least some examples of the apparatus may include at least one of a controller 900, a computer 910, a memory content 110, a form of a third agreement 1800 and/or a configuration 920 of the controller and/or the computer. The components of the apparatus may be seen through the examples of the transaction administration device 1400, the customer 1010 equipment 1300, the POS 1000 device 1080, the transaction controller 1500, the transaction domain resolver 1600, and/or the settlement notifier 1700 and/or the personal computing device 300.

The third agreement 1800 may involve the customer 1010 agreeing 1800 to an offer by a communication service provider 710, a resource provider 830, and/or one or more financial institutions 1050 to configure and/or support the transaction administration device 1400, the customer equipment 1300 and/or POS 1000 device 1080 the transaction administration device 1400, the customer 1010 equipment 1300, the POS 1000 device 1080, the transaction controller 1500, the transaction domain resolver 1600, and/or the settlement notifier 1700 to perform as described herein, creating the contract and executing the contract 1100 while keeping any financial information 1200 of the customer out of the POS device. In some implementations, the transaction administrator device may be implemented by a personal computing device operated by the customer as a user 10 discussed above.

The use of the phrase “and/or” will be shown through two examples:
First, something comprising A and/or B has three intended embodiments:
   Something comprises A but not B
   Something comprises B but not A
   Or something comprises A and B
For example, suppose that B includes B1 and B2, then something comprising A but not B refers to something comprising (A and not B1) or (A and not B2) or (A and not B1 and not B2).
Second, something comprising A, B and/or C has seven intended embodiments:
   Something comprises A but not B and not C
   Something comprises B but not A and not C
   Something comprises C but not A and not B
   Something comprises A and B and not C
   Something comprises A and C, and not B
   Something comprises B and C and not A
   Something comprises A and B and C

One skilled in the art will recognize that the operation of the various apparatus disclosed herein cannot be duplicated by humans using previously known economic procedures, nor are they abstract ideas devoid of the specifics of the machines performing these operations.

The states of the machines, particularly the memory content 110 residing in the persistent memory 100, the keys 782 and 784 and the merge-alter configuration 786 are not transient phenomena, but are instead tangible properties of the various apparatus in which they are embodied, being measureable over extended windows of time.

The preceding embodiments provide examples of the invention and are not meant to constrain the scope of the following claims.

What is claimed is:

1. An apparatus, comprising: a convenient trusted apparatus including a first secure channel interface and a configuration; wherein said convenient trusted apparatus responds to said configuration to
interact with a user of a focal computing device to request access to a secure resource;
operate said first secure channel interfaces and direct operation of a second secure channel interface to respectively send separately encrypted a first authentic component and a second authentic component that cause an authentic input to be received by said secure resource to authenticate access by said user, wherein said first and said second authentic components do not reveal said authentic input.

2. The apparatus of claim 1, wherein said convenient trusted apparatus further includes a password manager accessible by said user to retrieve said first authentic component and/or said second authentic component.

3. The apparatus of claim 1, wherein said convenient trusted apparatus includes said second secure channel interface.

4. The apparatus of claim 1, wherein said convenient trusted apparatus is implemented by at least one of a cell phone, a mobile entertainment device, a tablet computer, a wearable device, a wrist band, a desktop computer, a wireless router and/or a Wifi hot spot.

5. The apparatus of claim 1, wherein said convenient trusted apparatus includes at least one instance of at least one of a controller and/or a computer adapted to respond said configuration residing in a memory to at least partly implement said convenient trusted apparatus.

6. The apparatus of claim 5, wherein said memory is a persistent memory.

7. The apparatus of claim 6, wherein said configuration includes and/or is generated by at least one of a download, an installation package, an operating system, and/or an application.

8. The apparatus of claim 1, wherein said convenient trusted apparatus responds to said configuration based upon identifying said personal computing device as an acceptable focal computing device operated by said user.

9. The apparatus of claim 1, further comprising a trusted slave device including a second configuration, a local communications interface adapted for communication with said convenient trusted apparatus, said second secure channel interface and a second configuration;
wherein said trusted slave device responds to said second configuration and to said convenient trusted apparatus directing said second secure channel interface by operating said second secure channel interface to send said separately encrypted said second authentic component to create said authentic input for said secure resource to grant access to said user.

10. The apparatus of claim 9, wherein said trusted slave device further contains said second authentic component.

11. The apparatus of claim 9, wherein said trusted slave devices responds to said second configuration based upon identifying said personal computing device operated by said user as said acceptable focal computing device and identifying said convenient trusted apparatus interacting with said personal computing device in response to said configuration.

12. The apparatus of claim 9, wherein said trusted slave device includes at least one of a persistent memory, a cell phone, a mobile entertainment device, a tablet computer, a wearable device, a wrist band, a desktop computer, a wireless router and/or a Wifi hot spot.

13. The apparatus of claim 1, further comprising a trusted integration node configured to respond to receipt of said separately encrypted first authentic component and said separately encrypted second authentic component by generating said authentic input for presentation to said secure resource.

14. The apparatus of claim 13, further comprising said trusted integration node including a first secure channel receiver, a first key, a second secure channel receiver, a second key, a user identification, a merge/alter circuit, and a merge/alter configuration;
said first secure channel receiver is configured to respond to said first key and receipt of said separately encrypted first authentic component to create said first authentic component recreation;
said second secure channel receiver is configured to respond to said second key and receipt of said separately encrypted second authentic component to create said second authentic component recreation;
said merge/alter circuit is configured to respond to said merge/alter configuration, said first authentic component recreation and said second authentic component recreation by generating said authentic input for presentation to said secure resource.

15. The apparatus of claim 13, wherein said trusted integration node further configured to respond to said request for said web page to send said personal computing device said secure web page.

16. The apparatus of claim 13, wherein said trusted integration node is managed by at least one of a communications service provider and/or a secure resource provider.

17. An apparatus, comprising: a convenient trusted apparatus including a secure channel interface and a configuration; wherein said convenient trusted apparatus responds to said configuration to direct operation of secure channel interface to
interact with a user of a focal computing device to achieve access of a secure resource without any authentication being visible or performed by said focal computing device; and
cause an access request to be presented to said secure resource based upon said authentic input, that subsequently permits said user to access said secured resource from said focal computing device without revealing said authentic input to said focal computing device.

18. The apparatus of claim 17, wherein said convenient trusted apparatus is implemented by at least one of a cell phone, a mobile entertainment device, a tablet computer, a wearable device, a wrist band, a desktop computer, a wireless router and/or a Wifi hot spot.

19. The apparatus of claim 17, wherein said convenient trusted apparatus includes at least one instance of at least one of a controller and/or a computer adapted to respond said configuration residing in a memory to at least partly implement said convenient trusted apparatus.

20. The apparatus of claim UU04, wherein said configuration includes and/or is generated by at least one of a download, an installation package, an operating system, and/or an application.

21. The apparatus of claim 17, wherein said convenient trusted apparatus responds to said configuration based upon identifying said personal computing device as an acceptable focal computing device operated by said user.
